(19) United States
(12) Patent Application Publication
(10) Pub. No.: US 2010/0233649 A1
(43) Pub. Date: Sep. 16, 2010

(54) DEVICE FOR SONIC IRRIGATION AND ASPIRATION OF A ROOT CANAL AND METHOD OF USE THEREOF

(76) Inventors: John W. McPeek, Parker, CO (US); David Truwe, Maynard, CO (US)

Correspondence Address: Leyendecker & Lemire, LLC, Suite 280, 9137 E Mineral Circle, Centennial, CO, 80112, US

(21) Appl. No.: 12/401,763

(22) Filed: Mar. 11, 2009

(51) Int. Cl. A61C 1/07

(52) U.S. Cl. 433/86

(57) ABSTRACT

A hand held dental device that is utilized to irrigate and aspirate a root canal during a root canal procedure is described. The device includes multiple functionalities permitting a dentist to drip irrigant into a primary canal from an opening thereabove and remove the irrigant from proximate the apex of the tooth using suction through a thin cannula while agitating the solution within the canal at sonic frequencies ranging from about 6,000 to 12,000 hertz. On variation includes a pneumatically powered sonic driver to impart the necessary vibration to the cannula which in turn transfers the sonic energy to the pool of irrigant contained in the canal of a tooth.

### FIELD OF THE INVENTION

The present invention pertains to endodontics particularly devices and methods used during root canal procedures.

### BACKGROUND

A root canal comprises the main or primary canals within the dentin of a tooth. They are typically filled with a highly vascularized loose connective tissue referred to as dental pulp. This pulp sometimes becomes infected or inflamed and must be removed to prevent additional degradation of the tooth that could result in its loss. The procedure of removing the diseased pulp from the root canal is also commonly referred to as a root canal.

A root canal procedure comprises first drilling out the outer enamel and inner dentin from the top of the tooth to gain access to the root canal or pulp chamber. The easily accessible pulp is removed. Next, one or more endofiles are utilized to remove additional pulp and the tooth's nerve from inside the primary canals as well as smooth and clean the side surfaces of the canals.

Because the dentin surrounding the main canals is highly porous and because endofiles are not suitable for penetrating tributary canals that feed the primary canals, a sodium hypochlorite or chlorhexidine solution is typically used periodically between filing operations and after the filing operations are completed to not only flush out bacteria, dead tissue and debris but also kill any remaining bacteria retained in the tributary canals and pores of the dentin. The cleaning solution also acts to dissolve organic debris and as well as clear the walls of the root canal of calcific debris created during drilling and filing. In some applications, the cleaning solution may be heated to increase its effectiveness. Nevertheless, using known procedures it can be difficult to fully neutralize all bacteria located within the pores of the dentin and as such multiple sessions may be required to complete the procedure. Antimicrobial medications may be placed in the root canal between visits.

After the infection has been completely eradicated, the root canal is filled often with a biocompatible rubber-like material called “gutta percha” in combination with an antibacterial cement. Once the canal is filled, the opening at the top of the tooth is sealed with a permanent filling or a crown.

### BRIEF DESCRIPTION OF THE DRAWINGS

FIG. 1 is an isometric view of a hand held sonic irrigation and aspiration device according to one embodiment of the present invention.

FIG. 2 is an exploded isometric view of the rear portion of the device depicted in FIG. 1 according to one embodiment of the present invention.

FIG. 3 is an exploded isometric view of the front portion of the device depicted in FIG. 1 according to one embodiment of the present invention.

FIG. 4 is an exploded isometric view of the irrigant flow control button of the device depicted in FIG. 1 according to one embodiment of the present invention.

FIG. 5 is front end view of the main body section of the device of FIG. 1 according to one embodiment of the present invention.

FIG. 6 is rear end view of the main body section of the device of FIG. 1 according to one embodiment of the present invention.

FIG. 7 is top side view of the main body section of the device of FIG. 1 according to one embodiment of the present invention.

FIG. 8 is bottom side view of the main body section of the device of FIG. 1 according to one embodiment of the present invention.

FIG. 9 is a cross sectional view of the main body section taken along line 9-9 of FIG. 7 according to one embodiment of the present invention.

FIG. 10 is an exploded view of the sonic driver of the device of FIG. 1 according to one embodiment of the present invention.

FIG. 11 is an illustration demonstrating the manner in which the device of FIG. 1 is utilized to irrigated and aspirate a root canal according to one embodiment of the present invention.

FIG. 12 is a view of the canal insertion end of the FIG. 1 device specifically illustrating the cannula, a distal end of the irrigant flow tube and the funnel cap in cross section according to one embodiment of the present invention.

FIG. 13 is an isometric view of the top end of the main body section angled to illustrate the compressed air outlet therein according to one embodiment of the present invention.

FIG. 14 is a cross sectional view of the sonic driver according to one embodiment of the present invention.

### DETAILED DESCRIPTION

Embodiments of the present invention comprise a hand held dental device that is utilized to irrigate and aspirate a root canal during a root canal procedure. Advantageously, this single device permits a dentist to drip irrigant into a primary canal from an opening thereabove and remove the irrigant from proximate the apex of the tooth using suction through a thin cannula while agitating the solution within the canal at sonic frequencies ranging from about 6,000 to 12,000 hertz. The sonic agitation of the fluid contained within the root canal facilitates more effective cleaning and disinfecting of the porous walls of the primary canals as well as the tributary canals.

In at least one embodiment, the sonic agitation is provided by a pneumatic driver (or motor) contained within the dental device. Typically, a dentist is able to actuate the flow of a compressed gas, such as air, to through the driver using a foot pedal or other means to control the sonic agitation of the fluid within the root canal. The driver induces a sonic vibration in the device that is imparted into the liquid pool contained within the tooth by way of the cannula.

The construction of the driver can vary but in one variation it comprises a cylinder that circumscribes an at least partially hollow axle. The inside diameter of the cylinder is significantly larger than the outside diameter of the axle about which it rotates. The hollow axle serves as a conduit from compressed gas that flows through it and out one or more nozzle openings that extend generally radially outwardly through the axle wall. Operationally, the flow of compressed gas out of the nozzle openings causes the cylinder to rotate around the axle. Because of the significant delta between the inside and outside diameters of the cylinder and axle respectively, the axis of rotation of the cylinder is not coincident with the axis of rotation of the axle. Rather the location of the cylinder's axis of rotation constantly varies with respect to the axle's axis of rotation. Accordingly, the radial location of the cylinder's center of gravity, which it typically located on the axis of rotation, constantly varies effectively introducing sonic waves into the device at a frequency essentially equal to the number of times the cylinder rotates about the axle in a reference unit of time.

The handheld device also includes a funnel cap coupled with a flexible tube that extends from an irrigant outlet attachment on the body of the device to the cap. The cap typically fits over the root canal opening on the top of the tooth directs the flow of irrigant into the root canal. The cannula is typically slidably received through the sidewall of the tube and extends through the bore of the funnel cap. Accordingly, a dentist can maintain the position of the cap against the tooth's top opening continuing the flow of irrigant into the tooth while at the same time he/she moves the tip of the cannula upwardly and downwardly in the canal to more effective remove debris.

Collectively and individually, the embodiments and variations described herein and as recited in the appended claims permit a dentist or other dental professional to more effectively clean the interior canals of a tooth. It is to be appreciated that these embodiments and variations are exemplary and except as recited in the claims are not to be considered limiting on scope and protection.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase. The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. Concerning angular measurements, “about” or “generally” refers to +−10 degrees and “substantially” refers to +−5.0 degrees unless otherwise indicated. It is to be appreciated that not all uses of the above terms are quantifiable such that the referenced ranges can be applied.

As used herein, “titanium” refers not only to commercially pure grades of the metal but also metallic alloys in which titanium is a primary constituent.

As used herein, the term “dentist” is intended not only to refer to persons having a doctorate of dentistry but also other dental professionals duly certified by the appropriate governmental or industry body to perform root canal procedures or portions of root canal procedures.

The phrase “sonic driver” as used herein refers to any device which is designed and configured to intentionally generate vibration at desired frequencies.

The term “irrigant” as used herein refers to any suitable liquid that can be used in performing a root canal or other dental procedure for purposes of irrigating a tooth.

The term “conduit” as used herein refers to any passage for transporting substances from one locale to another. The substances can be liquid, gas or solid. Most notably in relation to the present document, a conduit can be one or both (i) a passage way fashioned within an article that does not exist separate from the article, such as a passage way in the main body of the device as described below, and (ii) a distinct element, such as a tube or pipe.

The terms “gas” and “air” unless otherwise clear in context are used interchangeably herein. For instance, a compressed gas can be compressed air or it could comprise a particular gas, such as nitrogen. Further, where the term “air” is used herein, it should not be understood as precluding the substitution of a suitable gas or gas mixture for “air”.

### An Embodiment of the Handheld Device

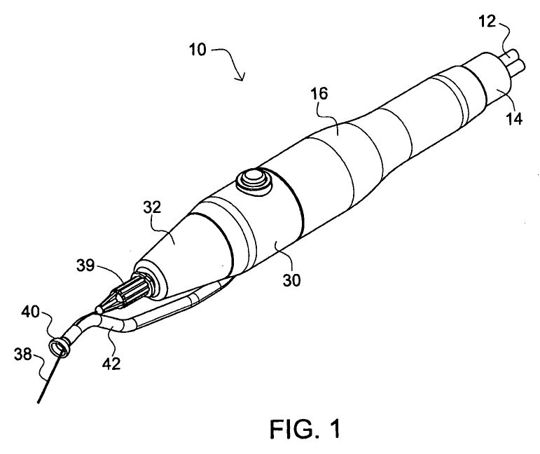

FIGS. 1-4 are illustrations of one embodiment of the handheld device shown in various states of assembly and disassembly for clarity.

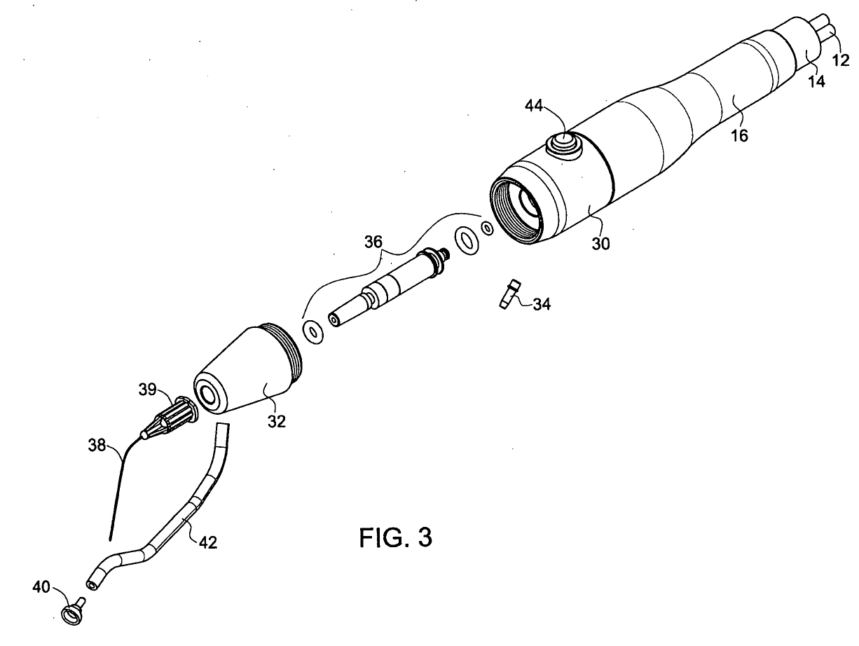

FIG. 1 is an illustration of the device 10 as assembled. Beginning from the proximal end, a plurality of resilient flexible supply tubes 12 extend outwardly from the device to operatively couple the device with actuators, exhaust outlets or other apparatus. A first tube supplies irrigant from a source to the device. The source typically includes a means of moving the fluid through the tubing such as a pump. Alternatively, the source may comprise a pressurized vessel that facilitates the flow of the irrigant when a button 44 (see FIG. 3) is depressed. It is to be appreciated that the rate of flow through the tubing is generally relatively low such that the dentist or other dental professional can easily control the volume of fluid deposited in the root canal. As a general rule, the rate of flow of irrigant from the source should be comparable to the rate at which the fluid can be sucked from the root canal through the cannula 38.

A second tube 12 is coupled to a compressor or other suitable source of pressurized gas, such as a compressed air tank, often by way of a foot pedal actuated valve that permits the dentist to selectively control the flow of compressed air to the pneumatic sonic driver 36 (as best shown in FIGS. 3 & 10). Rather than permit the compressed gas exiting the driver to dissipate at the device, where the resulting breeze could hamper the root canal procedure, a third tube 12 is provided to carry the gas away from the vicinity of a patient's mouth. The distal end of the third tube may just terminate or it may be connected to a suitable muffler.

A fourth tube 12 provides to provide the necessary suction or the aspiration of the root canal through the cannula 38. As can be appreciated, this tube is typically operatively coupled to a vacuum pump. A filter assembly is also typically provided to contain the used irrigant and associated dissolved and solid matter contained therein for later disposal.

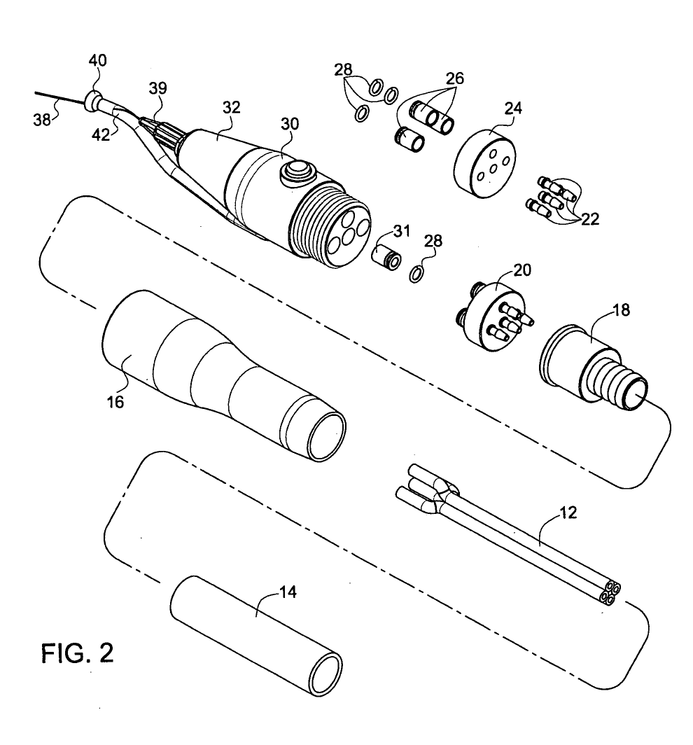

As best illustrated in FIG. 2, a flexible sleeve 14 having an inside diameter large enough to receive all four of the supply tubes therein can be provided. The purpose of the sleeve is to coalesce the four tubes proximate the device so that the individual tubes are less likely to catch or become entangled with the dentist, the dentist chair, the patient or any other surrounding objects. The sleeve may extend anywhere from a few inches to feet beyond the distal end of the device 10.

The supply tubes 12 are secured to a manifold assembly 20 and the flexible sleeve 14 is received over a sleeve clamp 18 that comprises a tubular portion having a plurality of annular barbs distributed lengthwise on an exterior surface. The manifold assembly and the clamp are secured to a main body 30 of the device by way of a rigid handle sleeve 16 in which the manifold and clamp are internally received. The proximal end of the handle sleeve comprises female threads (not shown) that are received over and around corresponding male threads 60 on the main body. In addition to securing the sleeve clamp 18 and the manifold assembly 20 in place, the handle sleeve also, as its name suggests, provides additional surface area for a dentist to grip the device while performing the root canal procedure.

An exploded view of the supply tube manifold assembly 20 is provided in FIG. 2. The manifold body 24 has four bores that extend through it from a proximal face to a distal face. Four supply tube connectors 22 are received snuggly and securely into the bores on the proximal face. The tube receiving ends of the connectors each include a tapered annular barb over which the end of a respective supply tube 12 is securely received.

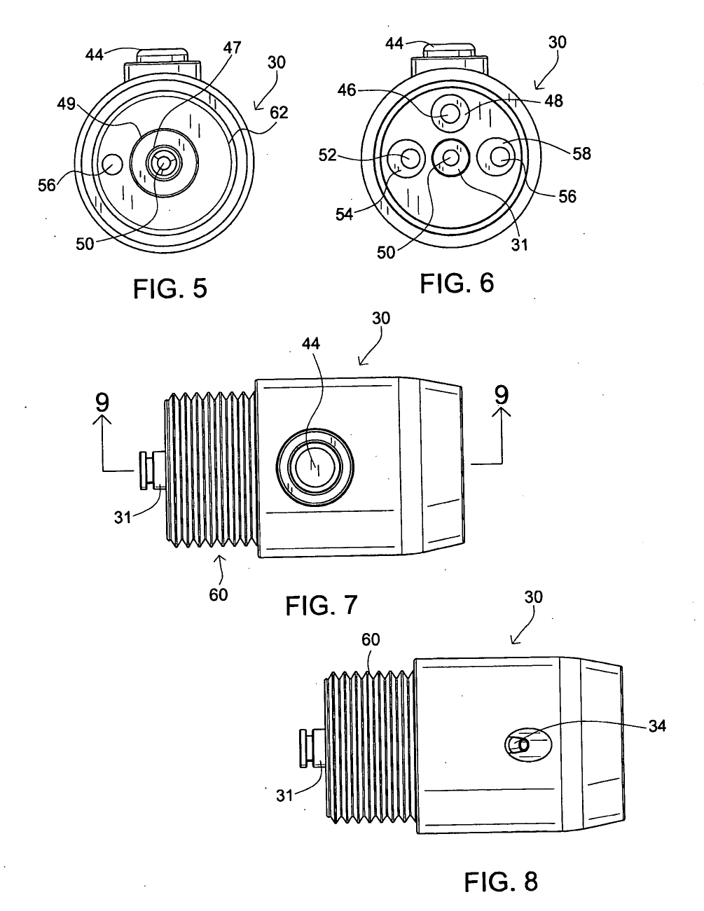

A set of three main body connectors 26 are provided to couple the manifold assembly 20 to the main body 30. The three connectors are snuggly and securely received in the manifold bores on the distal face through an interference fit. An o-ring 28 is provided that sits within an annular valley on a distal end of each of the connectors. The o-ring is adapted to permit the connector to be removably received into a respective conduit opening (see FIG. 6) in the main body but also form an airtight seal. A fourth and center main body connector 31 is provided that couples the vacuum conduit within the main body 30 with the manifold assembly 20. The fourth connector is substantially similar to the connectors 26 interference fit within the manifold including having an annular ridge over which an o-ring is received body. However, it is interference fit into the main body and the proximal end thereof is removably received into a corresponding center bore in the manifold body 24. It is to be appreciated the orientation and configuration of the various connectors of the manifold assembly along with the assembly itself can vary substantially in other variations and embodiments of the device.

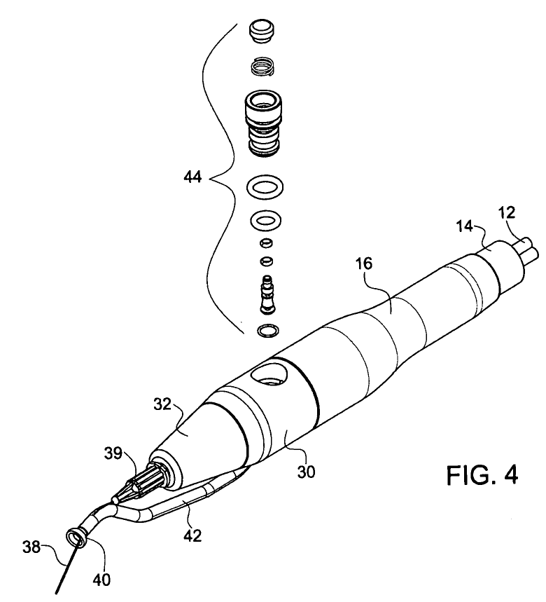

Referring back to FIG. 1, the main body 30 further acts to distribute the flow of compressed gas, exhaust gas, vacuum and irrigant to and from the distal end of the device. Perhaps most importantly, it includes a button assembly 44 (see FIG. 4) that permits a dentist to turn the flow of irrigant out of the funnel cap 40 and into a root canal off and on as is necessary during the procedure. It further provides a secure finger hold for the dentist. The main body is typically comprised of a corrosion resistant material, such as titanium, that will not oxidize in the presence of a corrosive irrigant solution. It is appreciated that variations are contemplated that are comprised of reinforced and unreinforced plastics as well as other corrosion resistant alloys. The main body is described in further detail below with reference primarily to FIGS. 4-9.

As shown in FIG. 1, a tapered shroud 32 is provided in front of the main body 30. The shroud covers and protects the sonic driver 36 that substantially resides in a bore extending through the shroud (see FIG. 3). The bore forms a chamber in which the compressed gas exiting the driver is funneled back towards the main body wherein it is ultimately directed into the exhaust air tube 12. As an added benefit, the shroud provides additional surface area for the dentist to hold the device during use.

As shown in FIG. 3, the proximal end of the shroud comprises a threaded male portion that is received into a female threaded cavity on the distal end of the main body 30. The cylindrical bore extending through the shroud has a diameter greater than that of the portion of the sonic driver 36 contained therein. This creates a space between the exterior wall of the driver and the wall of the bore that permits the exhaust gas to be funneled back to the main body. The front bore opening located at the distal end of the shroud has a smaller diameter than the bore itself creating an annular ridge that extends around the opening. This ridge acts as a stop that helps secure the sonic driver 36 in place and provides an abutment against an o-ring 76 on the driver seals the chamber hindering exhaust air from exiting the distal end of the shroud and possibly interfering with the root canal procedure.

The pneumatic sonic driver 36 extends from a connection with the main body 30 inside and along the shroud's cylindrical bore with a front portion extending outwardly of the bore's front end. The front portion is typically slightly tapered to snuggly receive a cannula with a Luer™ lock-type end fitting thereon. As indicated above the primary function of the sonic driver is to impart acoustic or vibrational energy into the cannula 38, which in turn is imparted into the pool of irrigant contained in a subject tooth. Greater detail concerning the construction and operation of the driver is provided below with primary reference to FIG. 10.

As indicated above the cannula 38 comprises a thin metallic needle that has a Luer lock type connector 39 or similar connector secured to its proximal end. The needle is typically comprised of a metallic material, such as a surgical grade stainless steel. The irrigant materials can have a deleterious effect on some surgical steels; however, since the needle is disposable and not reused, the corrosive effects to the needle during its effective life are minimal. Typically, the needle is closed at its bottom end and has one or more slots formed in the cylinder's sidewall proximate the closed distal end. Typically, 25 to 30 gauge needles are utilized with the slots being placed 1.5-5 mm from the end. To facilitate ease of use of the tool the needles are often bent anywhere from about 30-90 degrees along their lengths to facilitate more easy placement of the needle within a tooth root canal.

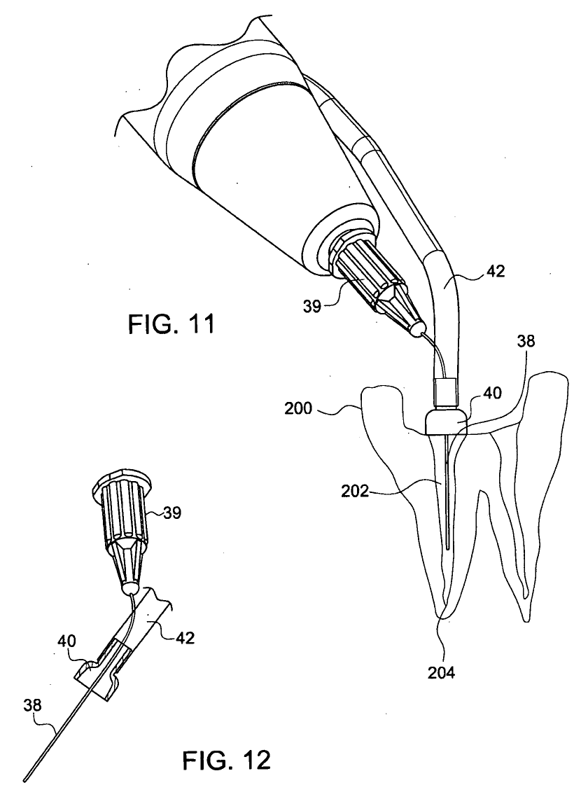

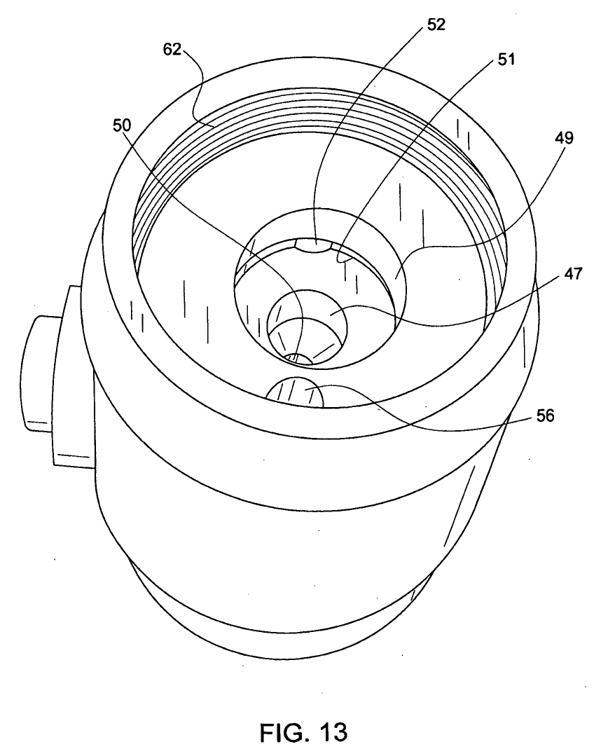

Irrigant is delivered to the tooth by way of a flexible elastomeric tube 42 that extends from an outlet port 34 on the main body 30 to a funnel cap 40. As best shown in FIG. 12, the needle portion of the cannula extends through the sidewall of the elastomeric tube proximate its distal end and through the bore of the funnel cap. As shown in FIG. 11 the bottom end of the funnel cap is configured to fit over and seal an underlying primary canal of the tooth 200 to help minimize the risk that sonically agitated irrigant will be projected beyond the immediate vicinity of the tooth and possibly cause irritation to the soft tissue surrounding the tooth. The tubing is often comprised of a silicone elastomer while the funnel cap is comprised of a suitable FDA approved plastic. As can be appreciated, the elastomeric tube and funnel cap are disposable and are not reused.

The main body 30 of the device is best described with primary reference to FIGS. 3-9 & 13. FIG. 6 is an illustration of the proximal end of the main body. It shows manifold assembly connections for the four conduits that extend through the body for the purpose of delivering and exhausting fluid, gas and other materials from the root canal during a procedure.

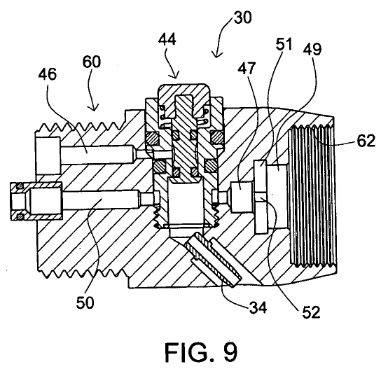

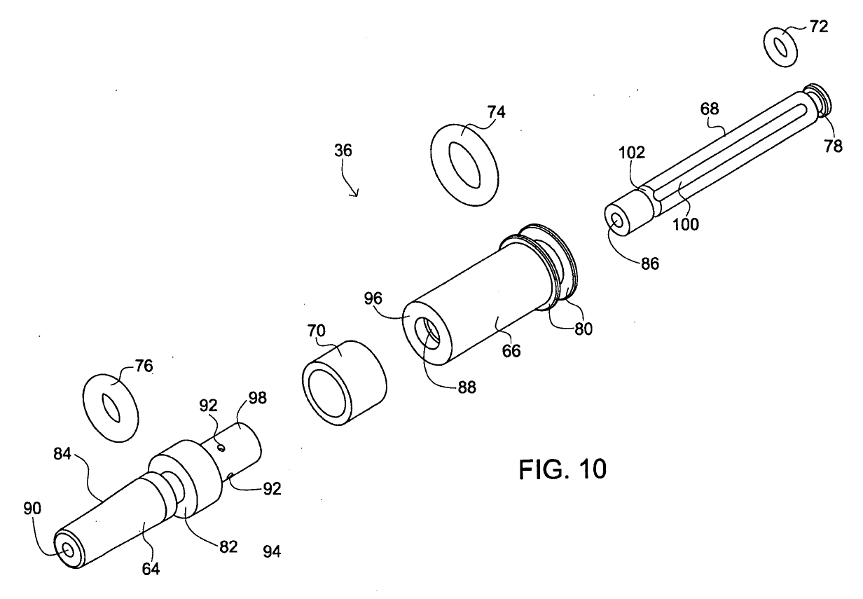

As described earlier, the center connection comprises a connector 31 that is typically interference fit and/or otherwise fixedly secured within a bore fashioned into the body. This connector is the beginning of the vacuum conduit 50 (or passageway) that extends to an outlet on the distal end as best shown in FIG. 5. As best shown in FIG. 9, the vacuum conduit is diverted from a direct linear path through the main body 30 by the button assembly 44, wherein a body of the button assembly includes a channel extending around its circumference that acts to operatively couple the proximal and distal portions of the vacuum conduit. The outlet on the distal end of the main body is adapted to couple with the sonic driver wherein the vacuum conduit continues as described in more detail below.

Referring back to FIG. 6, a left connection 54 comprises a cylindrical depression in the main body which is adapted to receive the corresponding connector 26 of the manifold assembly 20. As indicated above, the o-ring 28 on the connector acts to frictionally engage the connector within the depression as well as provide a generally air tight seal. The bottom of the depression intersects with the proximal end of the compressed gas conduit 52 that extends through the main body 30 exiting at an outlet on the distal end 52 (see FIG. 13). The conduit or passageway extends substantially directly through the main body 30, but it does not extend all the way through the body. Rather, the distal end of the compressed gas conduit terminates prior to reaching the body's distal end. However, the conduit's sidewall does pierce a largest of three concentric cylindrical depressions in the distal end of the main body that serve as the connection for the sonic driver 36. The sonic driver connection is described in greater detail below.

Referring to FIGS. 5 & 6, a right connection 58 also comprises a cylindrical depression in the main body which is adapted to receive the corresponding connector 26 of the manifold assembly 20. The bottom of the depression intersects with the proximal end of the exhaust gas conduit 56 that extends through the main body 30 exiting at an outlet opening 56 on the distal end. The conduit acts to direct exhaust gas channeled into it by the tapered shroud 32 to the manifold assembly 20.

The top connection 48 in FIG. 6 is similar to the left and right connections 54 & 58 in that it comprises a cylindrical depression in the main body which is adapted to receive the corresponding connector 26 of the manifold assembly 20. The bottom of the depression intersects with the proximal end of the irrigant delivery conduit 46 that extends through the main body 30 until reaching a button assembly 44 as best shown in FIG. 9. The button assembly 44 facilitates the continued flow of the irrigant through it when the button is depressed. The irrigant exits the main body 30 at a location along the sidewall thereof. A barb connector 34 is provided to interface with the flexible elastomeric tube 42 that is coupled with the funnel cap 40.

An exploded view of the button assembly is illustrated in FIG. 4 along with a cross sectional view in FIG. 9. The configuration and operation of the button assembly 44 is readily ascertainable to one of ordinary skill in the art from these Figures and as such will not be described in great detail. Suffice it to say that when the button is depressed on the normally closed assembly the irrigant solution is permitted to flow downwardly within button's body and out of its bottom end.

The construction and configuration of the pneumatic sonic driver 36 is best described with reference to FIGS. 10 & 14. The connection of the driver with the main body 30 is best described with reference to FIGS. 3, 5, 9 & 13. The sonic driver is typically machined from a metallic material, such as a corrosion and wear resistant titanium. It has four primary separately machined components: (i) a cylindrical driver body 66 including a bore 88 that extends its entire axial length; (ii) a generally cylindrical fluid flow distribution shaft 68 including an axial bore 86 that extends its length as well as a pair of opposing axially extending flutes 100 on its exterior surface; (iii) cannula connector 64 that also includes a bore 90 that extends its length and a tapered portion 84 over which a Luer lock type connector can be received; and (iv) a rotating cylinder 70 that is received over an axle portion 98 of the cannula connector. Several O-rings 72, 74 & 76 are also provided to facilitate removable connection of the driver to the body as well as provide gas seals to properly direct the flow of the compressed gas, the exhaust gas and the vacuum as desired.

Functionally, the driver when pneumatically activated induces a sonic vibration in the cannula 38 that is connected to it. The sonic driver also serves as a conduit for the vacuum between the main body 30 and the cannula by way of an axial bore comprised of the combined bores 86 & 90 of the fluid flow distribution shaft 68 and the cannula connector 64 respectively. As indicated above, the sonic vibration is induced by the driver through the use of compressed air to spin the rotating cylinder 70 off balance relative to an axis of the driver.

With reference to primarily FIGS. 10 & 14, the assembly and interconnection of the various components of the driver are described. First, the rotating cylinder 70 is received over the axle portion 98 of the cannula connector 64 until it abuts the proximal edge of a circumfrencial ridge 82. Next, the distal end of the bore 88 of the driver body 66 is placed over and secured to the exposed proximal end of the axle portion. The body can be secured to the cannula connector using any suitable means including adhesive bonding and/or interference fitment. Accordingly, the rotating cylinder, which has an inside diameter significantly greater than the outside diameter of the axle portion, can move and rotate freely about the axle. In one version, the outside diameter of the axle portion is about 0.158″; whereas, the inside diameter of the rotating cylinder is about 0.180″.

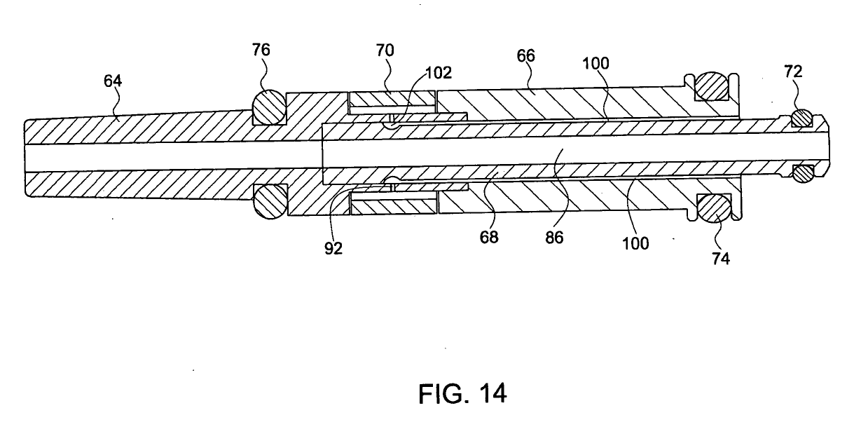

The fluid flow distribution shaft 68 is then pushed into the axial bore 88 of driver body 66 and from the proximal end thereof and into the axial bore in the cannula connector 64 until bottoming out on an internal circumferential ridge. A portion of the shaft remains exposed on its proximal end including the proximal ends of the flutes 100 and a first circumferential valley 78 in which one of the o-rings 72 is received. A cross section illustrating the assembled driver is provided in FIG. 14. The shaft is typically interference fit into the respective bores and as such forms a substantially air tight interconnection; however, adhesive can be utilized to further ensure the integrity of the joints. As can be ascertained from the Figures and the description the combination of the flutes 100 and the adjacent sidewalls of the respective bores act to form enclosed tubular conduits. As best seen in FIG. 10, the flutes terminate at a circumferentially extending channel 102 proximate the distal end of the shaft. Of important note, the circumferentially-extending channel aligns in the assembled driver 36 with one or more holes 92 passing through the wall of the axial portion 98 of the cannula connector 64. Operationally the conduits formed in part by the flutes 100 channel compressed air from the main body to the rotating cylinder causing it to spin and inducing sonic vibrations into the device and the cannula.

As previously mentioned, the driver 36 is removably received in the distal end of the main body 30. The proximal end of the driver, which includes the end of the fluid distribution shaft that extends outwardly of the proximal end of the driver body 66, is received in the innermost 47 of three concentric cylindrical depressions 47, 49 and 51 that also has the smallest diameter (see FIG. 13). The corresponding fluid distribution shaft o-ring 72 is snuggly received in the depression and acts not only to provide a frictional engagement of the driver with the main body but also to seal the junction of the main body's vacuum conduit 50 with the axial bores 86 & 90 of the driver ensuring an effective flow of vacuum at the tip of the cannula.

The cylindrical depression 51 having the largest diameter is located immediately above the smallest depression 47 and is most notable in that it includes the outlet for the compressed air conduit 52 on its sidewall as described above. When the sonic driver 36 is installed therein the proximal ends of the flutes 100 are located within this depression.

A second driver o-ring 74 is received between a pair of spaced radially extending protrusions 80 that encircle the driver body 66 proximate its proximal end. This o-ring is snuggly received in the distal-most cylindrical depression 49, which is positioned above the largest diameter depression 51, and acts not only to provide a frictional engagement of the driver with the main body but also to seal the junction of the main body's compressed air conduit 52 with the fluted compressed air conduits of the sonic driver.

A third driver o-ring 76 is provided in a circumferential valley located between the circumferential ridge 82 and the tapered portion 84 of the cannula connector 64. This o-ring serves to stabilize the sonic driver 36 in the tapered shroud 32 but also to seal the air space between the bore of the shroud and the exterior surface of the portions of the driver contained within the shroud.

The three elastomeric driver O-rings 72, 74 & 76 all also act to minimize the transference of vibrational energy to the device 10, excepting the driver itself and the cannula 38, through dampening and hysteresis. Accordingly, the vibration does not fatigue the dentist's hand and/or negatively impact his/her ability to precisely manipulate the device during a procedure.

### Operation of an Embodiment of the Handheld Device

Prior to using the handheld device 10 to irrigate and aspirate a root canal, the dentist will typically use one or more endodontic files to remove the soft tissue from the primary canals of the tooth as described above. Often a dentist will irrigate and aspirate the canals between switching from a smaller file to a larger file, but regardless, the dentist will irrigate the canals after filing has been completed to dissolve remaining tissue, disinfect the porous sidewalls of the canals and tributary canals, and flush out any remaining soft tissue.

The use of the device is best described with reference to FIG. 12. Initially, the tip of the cannula 38 is placed near the apex 204 of the tooth 200. The funnel cap 40 is placed over the entrance to the particular canal 202 being irrigated by sliding it along the cannula. The dentist activates vacuum suction through the cannula and depresses the button 44 on the device to begin the flow of irrigant. The irrigant flushes and dissolves any debris within the canal and along the canal walls.

As indicated above, it can be difficult to get the irrigant to penetrate the porous sidewalls of the canal that may have become packed with debris during the filing phase of the procedure. The debris contained within or on the walls of the canal can comprise infected tissue and bacteria. The debris can also act as a barrier that protects bacteria that lies behind the surface of the wall from the disinfectant irrigant. Furthermore, the tributary canals that are too small to be filed or reached by the cannula may also contain soft tissue that the irrigant cannot easily reach to disinfect or dissolve.

By activating the sonic driver 36, such as by depressing a foot pedal to permit the flow of compressed gas through the device, the dentist can sonically agitate the pool of irrigant contained in the canal. Typically, the rotating sleeve 70 of the driver rotates at a speed of 6,000-12,000 rpm depending on the design of the driver and the pressurization of the compressed gas. Each rotation of the sleeve results in a sonic cycle being induced into the driver and transmitted to the irrigant through the cannula. Typically, the driver vibrates at a frequency of 6,000-12,000 hertz although variations are contemplated that operate at higher and lower frequencies.

The energy imparted into the irrigant in the form of sonic vibrations acts to help work loose debris that is packed into the porous canal sidewalls. Further, it encourages the irrigant to more effectively penetrate the tributary canals and pores of the sidewalls.

To further increase the effectiveness of the canal cleaning, the dentist may move the cannula tip upwardly and downwardly within the canal to capture and remove tissue that was not flushed to the canal's apex. The process of moving the cannula to aspirate various sections of the canal has been found to be most effective and efficient when the irrigant is permitted to continue to flow into the tooth. Accordingly, the dentist will often hold the funnel cap 40 in place on top of the tooth while he moves the cannula thereby ensuring continuous or partially continuous flow of irrigant.

The irrigation procedure may be performed multiple times during a root canal procedure as deemed necessary by the dentist; because the irrigation, aspiration and sonic agitation functions are all contained within the device efficiencies can be gained by not having to switch out as often among various tools and instruments. Further, the effectiveness of the root canal procedure is enhanced

### Other Embodiments and Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For instance, variations are contemplated wherein the device further includes a heater for warming the irrigant solution. Warm irrigant has shown to be more effective than colder solutions. Alternatively, the irrigant solution can be heated at the supply reservoir or inline along the supply tube 12.

While the sonic driver described in the illustrated embodiments is pneumatic, it is appreciated that variations and embodiments are contemplated that utilize other technology to impart the sonic energy into the cannula. For instance, a piezoelectric driver or an electric motor with an off balance shaft can be utilized.

As described herein, the main body and the driver of the device are comprised primarily of metallic materials generally and titanium specifically. Further, most of the remaining parts are comprised of plastic or in the case of the O-rings and hoses, elastomers. It is to be appreciated that the metallic parts can be comprised of certain polymeric materials and that many of the plastic parts can be fabricated from metallic materials as well.

I claim:

1. An apparatus for the sonic irrigation of a root canal of a tooth, the apparatus comprising:
a cannula including one or more openings proximate a distal end, a handpiece connector at the proximal end and a lumen extending from the one or more openings to the handpiece connector;
a handpiece assembly including
(i) an negative pressure conduit formed therein including a negative pressure inlet and a negative pressure outlet,
(ii) an irrigant fluid conduit formed therein including an irrigant inlet and an irrigant outlet,
(iii) a cannula connector coupled to the handpiece connector, the negative pressure outlet being located proximate the connector the cannula connector facilitating fluid communication between the lumen and the negative pressure conduit,
(iv) a sonic driver, the sonic driver being adapted to induce sonic vibrations into at least the cannula;
a funnel cap having a bore extending therethrough with an inlet and an outlet; and
flexible tubing, the flexible tubing being coupled at a proximal end to irrigant outlet and at a distal end to the funnel cap inlet facilitating the flow of irrigant from the handpiece through the bore of the funnel cap;
wherein the funnel cap is slidably received on the cannula with the cannula passing through the bore.

2. The apparatus of claim 1, wherein the funnel cap is adapted to cover an excavated portion or a tooth surrounding a root canal.

3. The apparatus of claim 1, wherein the handpiece assembly further comprises an activator switch to selectively permit or prohibit the flow of irrigant through the irrigant conduit, the flexible tubing and out the funnel cap outlet.

4. The apparatus of claim 1, wherein the sonic driver is pneumatically driven and wherein the handpiece assembly further comprises a compressed air delivery conduit having a compressed air inlet and being in functional communication with the sonic driver.

5. The apparatus of claim 1, wherein the sonic driver is pneumatically driven, and wherein the handpiece assembly further comprises (a) a compressed air delivery conduit in fluid communication having a compressed air inlet and being in functional communication with the sonic driver, and (b) an exhaust air conduit having an exhaust outlet and being in fluid communication with the sonic driver.

6. The apparatus of claim 1, wherein the sonic driver is pneumatically driven, the sonic driver comprising:
a shaft assembly, the shaft assembly including (a) a shaft longitudinal axis (a) a circumfrencially-extending orbiter bearing surface bounded by proximal and distal radially outwardly extending edges, (b) a first lumen extending from a proximal end to a distal end, the first lumen comprising a portion of the negative pressure conduit, (c) at least one second lumen extending from the distal end to one or more outlets on the orbiter bearing surface;
a orbiter sleeve, the orbiter sleeve being loosely received over the orbiter bearing surface to permit rotational movement relative to the shaft generally about the longitudinal axis.

7. The apparatus of claim 1, wherein the sonic driver vibrates at a frequency of 6,000-12,000 hertz.

8. The apparatus of claim 1, wherein the body is comprised substantially of titanium and polymeric materials.

9. The apparatus of claim 4, wherein the sonic driver is substantially comprised of titanium.

10. The apparatus of claim 1 wherein the cannula comprises stainless steel.

11. The apparatus of claim 2 wherein the cannula passes through (i) the wall of the flexible tubing at a location proximate its connection with the funnel cap, and (i) the bore of the funnel cap.

12. The apparatus of claim 4 further comprising four flexible distribution tubes: a first tube being coupled with the irrigant inlet at a first end and being adapted to couple with an irrigant reservoir at a second end; a second tube being coupled to the negative pressure inlet at a first end and being adapted to couple with a vacuum source at the second end; a third tube being coupled to the compressed air inlet at a first end and being adapted to couple with compressed air source at a second end; and a fourth tube being coupled to the an exhaust outlet.

13. The apparatus of claim 1 wherein the handpiece connector is directly coupled with the sonic driver.

14. The apparatus of claim 14, wherein the handpiece connector comprises a Luer™-style connector.

15. A method of irrigating a root canal of a tooth having an apex end and a coronal end using the apparatus of claim 1, the method comprising:
inserting the cannula into the root canal through the coronal end and placing the distal end proximate the apex end;
positioning the funnel cap over and on top of the coronal end;
selectively supplying an irrigation fluid to the root canal through the funnel cap;
producing an acoustic wave within the irrigation fluid surrounding the cannula by sonically vibrating the cannula; and
selectively applying suction through the one or more openings proximate the distal end of the cannula.

16. The method of claim 15, further comprising selectively moving the distal end of the cannula upwardly and downwardly while maintaining the position of the funnel cap over and on top of the coronal end.

17. The method of claim 15, wherein the acoustic wave has a frequency of 6-12 khz.

18. The method of claim 15, wherein the sonic driver is pneumatically driven and said producing an acoustic wave comprises activating the driver by supplying a stream of pressurized air to the sonic driver.

19. The method of claim 15, further comprising warming the irrigation fluid prior to said supplying an irrigation fluid to the root canal.

20. An apparatus for the irrigation of a root canal of a tooth, the apparatus comprising:
a cannula including one or more openings proximate a distal end, a handpiece connector at the proximal end and a lumen extending from the one or more openings to the handpiece connector;
a handpiece assembly including
(i) an negative pressure conduit formed therein including a negative pressure inlet and a negative pressure outlet,
(ii) an irrigant fluid conduit formed therein including an irrigant inlet and an irrigant outlet,
(iii) a cannula connector coupled to the handpiece connector, the negative pressure outlet being located proximate the connector the cannula connector facilitating fluid communication between the lumen and the negative pressure conduit,
(iv) a pneumatic sonic driver, the sonic driver being adapted to induce sonic vibrations of about 6,000 to 12,000 hertz into at least the cannula,
(v) a compressed air delivery conduit having a compressed air inlet and being in functional communication with the sonic driver,
(vi) an exhaust air conduit having an exhaust outlet and being in fluid communication with the sonic driver, and
(vii) an activator switch to selectively permit or prohibit the flow of irrigant through the irrigant conduit;
a funnel cap having a bore extending therethrough with an inlet and an outlet, the funnel cap being adapted to cover an excavated portion or a tooth surrounding a root canal; and
flexible tubing, the flexible tubing being coupled at a proximal end to irrigant outlet and at a distal end to the funnel cap inlet facilitating the flow of irrigant from the handpiece through the bore of the funnel cap;
wherein the funnel cap is slidably received on the cannula with the cannula passing through the bore.
